(19) United States
(12) Patent Application Publication
(10) Pub. No.: US 2008/0118899 A1
(43) Pub. Date: May 22, 2008

(54) Methods for Assessing Neurocognitive Disorders

(76) Inventors: Barbara Sahakian, Cambridge (GB); Andrew Blackwell, Cambridge (GB)

Correspondence Address: MORRISON & FOERSTER LLP, 1650 TYSONS BOULEVARD, SUITE 400, MCLEAN, VA, 22102, US

(21) Appl. No.: 11/578,368

(22) PCT Filed: Apr. 13, 2004
(86) PCT No.: PCT/GB04/01604

§ 371 Date: Aug. 3, 2007

(51) Int. Cl. G09B 19/00

(52) U.S. Cl. 434/236

(57) ABSTRACT

This invention relates to the identification of individuals in the population who are at particular risk of suffering from disorders associated with neurocognitive degeneration, such as Alzheimer's disease (AD).

The prevalence of Alzheimer's disease (AD) in the general population is set to reach epidemic levels (Hebert et al, (2003)). Treatment with anti-dementia agents is most effective in patients in the early stages of Alzheimer's disease (AD) and it is therefore important to identify individuals who are at risk of suffering from AD or who are in the earliest stages of the disease in order to optimise therapeutic outcomes (Petersen et al, 2001; Petersen et al 2003; de Kosky, 2003). It is also important not to treat individuals who do not have Mild Cognitive Impairment (MCI) or AD so that they are not exposed to potential side-effects of these drugs and to avoid unnecessary costs. Accurate and early diagnosis of neurocognitive disorders such as MCI and AD is thus the sine qua non of cost- and therapeutically effective anti-dementia treatment.

Previous studies have suggested that episodic memory tests are sensitive to Mild Cognitive Impairment (MCI) and AD [Swainson et al, 2001; de Jager et al 2003] and decline in performance on these tests is associated with medial temporal atrophy, the site of earliest pathology in AD [Braak and Braak, 1991; Nagy et al, 1996].

It has recently been reported that the conversion of patients suffering from questionable dementia to probable AD (NINCDS-ADRDA criteria) can be predicted using a combination of age and two neuropsychological test measures (CANTAB PAL (Sahakian et al., (1988)) and Graded Naming (GNT: McKenna & Warrington, (1980)) (Blackwell A D et al (2004) Dement Geriatr Cogn Disord 17:42-8).

There is a need for improved neuropsychological tests to provide accurate prediction of the onset of AD in individuals who do not demonstrate symptoms of the disorder.

The present inventors have recognised that certain combinations of neuropsychological tests, in particular visuospatial learning and memorising tests, such as CANTAB PAL, and semantic memory tests, such as GNT, can be used to accurately predict the risk of AD in healthy individuals who have no clinical diagnosis indicative of cognitive decline or neurocognitive disorders or abnormalities.

One aspect of the invention provides a method of assessing the risk of a neurocognitive disorder in an individual comprising;
assessing the visuospatial learning and memory ability and semantic memory of said individual to produce a visuospatial learning and memory ability score and a semantic memory score for the individual, and;
determining from said scores the risk of a neurocognitive disorder in said individual.

An individual may have normal cognitive function (i.e. cognitive function which is classified as normal or unimpaired by standard tests such as MMSE), or may have a mild clinical impairment such as Questionable Dementia, Mild Cognitive Impairment, Age-Associated Memory Impairment, Mild Neurocognitive Disorder, or a Clinical Dementia Rating (CDR) of 0.5.

An individual whose cognitive function is classified as normal or unimpaired may not display neurocognitive abnormalities of a nature and severity which is consistent with a diagnosis of a neurocognitive disorder or impairment. In other words, the individual does not meet any neuropsychiatric diagnostic criteria, for example for questionable dementia, dementia, Mild Cognitive Impairment, Age-Associated Memory Impairment, Mild Neurocognitive Disorder, AD or other neurocognitive disorder. For example, an individual with normal neurocognitive function may have a Clinical Dementia Rating (CDR) of 0. In some embodiments of the invention, an individual whose cognitive function is classified as normal may not display any overt or clinically recognizable symptoms of a neurodegenerative condition or dementia, such as subjective memory loss or objective memory loss (as defined by standard tests).

Neuropsychiatric diagnostic criteria are set out, for example in the Diagnostic and Statistical Manual of Mental Disorders (text revision), American Psychiatric Association (2000) American Psychiatric Publishing Inc (DSM-IV-TR). Neuropsychiatric criteria include criteria for dementia of the Alzheimer's type (ref: 294.1x p 154-158; DSM IV-TR) and Age-related Cognitive Decline (ref: 780.99 p 740; DSM IV-TR).

In preferred embodiments, an individual suitable for assessment as described herein does not display neurocognitive abnormalities of a nature and severity consistent with a diagnosis of a neurocognitive disorder or impairment and has a level of cognitive function which is classified as normal using conventional testing criteria.

The risk of neurocognitive disorder includes the risk or probability that the individual will suffer from, or be diagnosed with a neurocognitive disorder or abnormality within a predetermined period of time, for example 12, 24, 32, 36 or 48 months, after assessment, for example the risk or probability that the individual will be diagnosed with probable AD (pAD).

A diagnosis of pAD may be made, for example, using the NINCDS-ADRDA criteria or Dementia of the Alzheimer's type using DSM IV criteria, or similarly accepted criteria (e.g. ICD-10; see references).

An individual assessed in accordance with the present methods may be assigned to a high or a low risk classification according to the determined risk or probability of a neurocognitive disorder. An individual with a probability of suffering from a neurocognitive disorder or abnormality which is greater than a threshold value may be classified as high risk. For example, an individual may be classified as a high risk if the probability is greater than 0.05 or low risk if the probability is less than 0.05.

An individual who is classified as high risk may be subjected to increased monitoring of cognitive function and/or assessed for anti-dementia treatment.

In some embodiments, the visuospatial memory and learning ability and semantic memory of the individual may determined at a single time point. In other embodiments, the visuospatial memory and learning ability and semantic memory of the individual may determined at two or more time points. Suitable time points may, for example, be 1, 2, 3 or 4 or more years apart. The individuals who are identified as high risk at two or more time points may be classified as particularly high-risk. In other words, individuals are assigned to a high or a low risk classification based on the lowest risk determined at the two or more time points.

Visuospatial memory and learning ability is preferably assessed using a paired associates learning test. Various forms of paired associates learning test are known in the art. In preferred embodiments, the Cambridge Neuropsychological Test Automated Battery (CANTAB: Cambridge Cognition Ltd, Cambridge UK) visuospatial paired associates learning (PAL) test may be used (Sahakian et al. (1988) Brain 111: 695-718).

CANTAB PAL involves the sequential display of 1, 2, 3, 6 or 8 patterns in boxes on a display. Each pattern is then presented in the centre of the display and the subject is required to touch the box in which the pattern was previously seen. If all the responses are correct, the test moves on to the next stage; an incorrect response results in all the patterns being redisplayed in their original locations, followed by another recall phase. The task terminates after 10 presentations and recall phases if all patterns have not been placed correctly. The test may be scored in a variety of ways, including for example number of stages passed. Preferably, the test is scored by the number of errors made at 6-pattern stage.

Visuospatial memory and learning ability may also be assessed using memory or recognition memory tests with abstract stimuli or non-abstract stimuli morphed to appear abstract. A number of suitable tests are known in the art.

Various semantic memory tests are known in the art. In preferred embodiments, a graded naming test, for example GNT (McKenna P, Warrington EK (1980) J Neurol Neurosurg Psychiatry 43:781-8) may be used. Other tests of object naming (e.g. Boston Naming Test) may also be employed.

In a typical semantic naming test, subjects are shown a series of images (e.g. pictures, photographs or drawings), for example 10, 20, 30, 40, 50, 60, 70 or more drawings. Subjects are asked to identify the image (i.e. name what each image represents), and their response is recorded. The total number of items named represents the score for the test.

The age of the individual may be analysed along with the test scores in semantic memory and visuospatial learning/memory ability to determine the risk of neurocognitive disorder.

The risk of cognitive disorder may be determined from the test scores and age of the individual, using a predictive model.

A suitable predictive model may be produced from the visuospatial learning/memorising ability scores and semantic memory scores of a sample of individuals who are subsequently monitored over time for the onset of cognitive disorder, in particular, a neurocognitive disorder, such as AD.

A method of producing a predictive AD diagnostic algorithm or model may comprise;
assessing the visuospatial learning ability and memory and semantic memory of a sample of individuals, to produce visuospatial learning and memory ability scores and semantic memory scores for each member of said sample and;
monitoring the cognitive function of each of said members over a time course to determine the cognitive outcome for each of said members, and;
relating scores and age of each of said individuals with the cognitive outcome to produce a predictive algorithm which relates said test scores and age to the odds (and/or probability) that an individual will subsequently suffer from cognitive disorder.

A individual may then be assessed for risk of neurocognitive disorder by producing a visuospatial learning ability score and a semantic memory score for the individual as described above; and,
applying the predictive algorithm to the scores and the age of the individual to determine the risk of neurocognitive disorder in said individual.

In preferred embodiments, the individual may not display neurocognitive abnormalities of a nature and severity consistent with a diagnosis of any neurocognitive disorder (i.e. the individual may have neurocognitive function which is classified as normal using standard tests as described above).

In some embodiments, test scores and outcomes for the sample may be analyzed using multivariate logistic regression analysis, for example using a forward ‘likelihood ratio’ method or discriminant function analysis, preferably using age as a covariate, to produce a regression equation which defines the risk (and/or probability) that an individual will subsequently suffer from cognitive disorder, for example a neurocognitive disorder, such as AD or MCI. Probable AD may be diagnosed, for example, using the NINCDS-ADRDA, DSM-IV,ICD-10 or similarly accepted criteria.

In preferred embodiments in which visuospatial learning and memory ability is assessed using CANTAB PAL and semantic memory is assessed using GNT, the risk of cognitive disorder may be determined using a regression equation which employs the individuals age and test scores for the number of errors at the 6-pattern stage of CANTAB PAL and the total number of items named on the GNT as co-variates. For example, the probability of the onset of neurocognitive disorder in an assessed individual may be determined from the test scores using the formula:

log odds AD(x)=−115.742+(4.254×Age)+(6.517×Y)×(13.87×Z)

where Y=errors at the 6-pattern stage of CANTAB PAL, and; Z=total items named on the GNT (/30).

The odds of AD onset is e^{x} and the probability of AD onset is e^{x}/(1+e^{x}).

A method may further comprise identifying the individual as being in the high-risk category for onset of neurocognitive disorder. As described above, an individual may be classified as a high risk if the probability of AD onset is greater than a predetermined threshold value, for example 0.05.

An individual identified as high risk using a method of the invention may be targeted or prioritised for anti-dementia treatment. Suitable anti-dementia therapy may be provided for administration to the individual.

In particular, an individual identified as high risk using a method described herein may be included in treatment trials for anti-dementia treatments (i.e. may form part of an ‘enriched sample’).

In some embodiments, a method may comprise administering an anti-dementia therapy to an individual identified as at risk of neurocognitive disorder using a method described herein. Anti-dementia therapy may include, for example, administration of cholinesterase inhibitors, statins, NMDA antagonists, amyloid therapies, anti-inflammatories, oestrogen, anti-oxidants, ampakines, nootropics, secretase inhibitors, vitamin therapies or other glutamate receptor modulators.

Methods of the invention may be useful in screening programs, in particular in screening healthy members of the population who do not meet any neuropsychiatric diagnostic criteria and have no recognised clinically significant symptoms of neurodegeneration or dementia, such as objective or subjective memory loss.

An individual may be assessed for anti-dementia treatment by a method comprising;
assessing the visuospatial learning and memory ability and semantic memory of the individual, to provide a visuospatial learning and memory ability score and a semantic memory score, and;
determining the probability of neurocognitive disorder in said individual using said scores,
an individual having a high risk of neurocognitive disorder being a candidate for anti-dementia treatment.

Individuals suitable for assessment may have no clinical neurocognitive impairment or may have a mild clinical impairment, as described in more detail above.

Preferably, an individual has no clinical neurocognitive impairment and has normal neurocognitive function as defined by standard tests, such as the MMSE test.

Methods of the invention may be particularly useful in identifying ‘enriched’ populations of high-risk individuals, for example for trials of anti-dementia therapies.

Another aspect of the invention provides a method of identifying a population of individuals who are at high risk of neurocognitive disorder comprising,
identifying a sample of individuals,
assessing the visuospatial learning and memory ability and semantic memory to provide a visuospatial learning and memory ability score and a semantic memory score for each of the individuals in said sample,
determining the risk of neurocognitive disorder in each of said individual using said scores, and;
identifying a population of individuals within the sample who are at high risk of neurocognitive disorder.

The sample may comprise or consist of individuals having no clinical cognitive impairment or having a mild clinical impairment such as Questionable Dementia, Mild Cognitive Impairment, Age-Associated Memory Impairment, Mild Neurocognitive Disorder, or a Clinical Dementia Rating (CDR) of 0.5.

In some preferred embodiments, the sample is a non-clinical sample and may consist of individuals who may not display neurocognitive abnormalities of a nature and severity which is consistent with a diagnosis of any neurocognitive disorder Individuals may be assessed for full-scale IQ and screened for neurocognitive disorders, including dementia, depression, and subjective or objective memory complaints. Individuals with these conditions may be excluded from the sample.

Individuals in the population identified as being at high risk may be treated with anti-dementia therapy, as described above. The cognitive function of the individuals may be monitored following treatment and any subsequent onset of neurocognitive disorder determined.

The onset of a neurocognitive disorder such as AD or MCI may be determined by periodically monitoring the global cognitive function of said members subsequent to said administration, for example using the MMSE test (Folstein M F et al J Psychiatr Res 1975; 12:189-198), at 1, 2, 3, 4 or more time points.

As described above, methods of the invention may be particularly useful in identifying patient cohorts for trials of anti-dementia agents. A putative anti-dementia therapy may be administered to individuals within the population identified as being at high risk of neurocognitive disorder and subsequent cognitive function monitored relative to a control group of other individuals within the population identified as being at high risk of neurocognitive disorder, who have not received the putative therapy.

Improvements in cognitive function relative to the control group (e.g. the high-risk individuals that did not receive the active anti-dementia agent) may be indicative that the putative agent has a beneficial effect.

Aspects of the present invention will now be illustrated with reference to the accompanying figures described below and experimental exemplification, by way of example and not limitation. Further aspects and embodiments will be apparent to those of ordinary skill in the art.

All documents mentioned in this specification are hereby incorporated herein by reference.

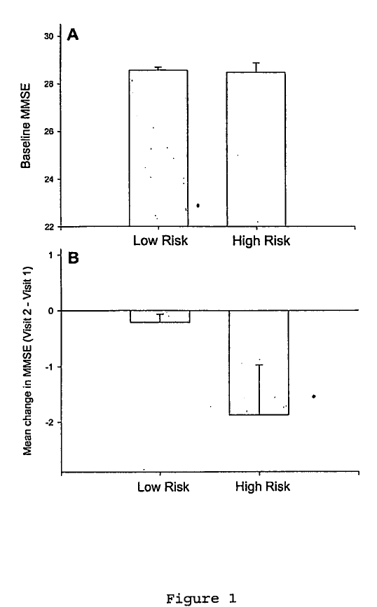

FIG. 1 shows the Mean Baseline Mini Mental-State Examination (MMSE) scores of individuals in the Low- and High-Risk groups (one-visit prognosis) (FIG. 1A) and the mean change in MMSE between first and second visit (FIG. 1B).

Table 1 shows the baseline characteristics of Low Risk and High Risk groups (one-visit prognosis).

Table 2 shows the prognosis based on one V1 only versus outcome

Table 3 shows prognosis based on V1 & V2 versus outcome

### EXPERIMENTAL

### Methods

### Subjects: Assessment and Inclusion Criteria

One hundred and fifty five healthy, community-dwelling volunteers over 60 years of age were recruited through talks and radio advertising for those who thought that their health, memory and thinking were good compared to that of their peers [de Jager et al, 2002]. Screening for dementia, depression, full-scale IQ and subjective memory complaint has been previously described, as have inclusion and exclusion criteria for the study (Blackwell et al (2004) supra). Medical history and examination, medication, smoking, alcohol and beverage intake and use of vitamin supplements were also documented. Ethical approval was granted from the Central Oxford Research Ethics Committee. Informed consent was obtained from all participants for all testing. Neuropsychological assessments were performed independently of the screening visit.

A neuropsychological battery was administered at baseline (visit 1) and twice more at 2 yearly intervals, (visits 2 and 3). The neuropsychological battery was designed to focus on episodic memory with tests using both verbal and visual learning material for recognition and recall. Tests, in addition to those previously described [de Jager et al, 2002], included visuospatial paired associates learning (PAL) from the Cambridge Neuropsychological Test Automated Battery (CANTAB, Cambridge Cognition Ltd, Cambridge UK) and the Graded Naming Test for semantic memory. The PAL was scored on the set with 6 items for memory, number of trials to completion and number of errors.

After visit 3, subjects were clinically evaluated for diagnosis by a geriatrician (MB) and a research psychologist (CdJ). Patients were classified as MCI if they scored 1.5 SD below the norms for age on at least one memory test at visit 3, had shown some evidence of decline in memory performance from baseline, did not have symptoms of overt cerebrovascular disease or dementia and were still functioning in the community.

### Prognostic Index/Risk Classification

A regression equation was constructed to estimate the odds (and probability) that an individual of a given age and PAL and GNT performance score will go on to receive a diagnosis of probable AD (pAD) within 32 months (‘conversion probability’).

The regression equation is:

log oddsAD(x)=115.742+(4.254×age)+(6.517Y)−(13.87Z)

where Y=errors at the 6-pattern stage of CANTAB PAL and Z=total items named on the GNT(/30).

Exponentiating this term (e^{x}) gives the odds that the individual will develop AD. The predicted probability of this individual going on to receive a diagnosis of probable AD within the next 32 months can then be calculated using the following equation:

probability of AD=e^{x}/(1+e^{x}).

### Analytical and Statistical Procedures

Measures chosen from each test were those deemed to load most heavily and specifically upon the psychological function that the test was being used to assess.

Differences between group means were tested for statistical significance using one-way ANOVA or non-parametric Kruskal-Wallis ANOVA as appropriate. Untransformed scores are presented in table 1. In order to decrease skew and stabilize variances some data were re-expressed prior to parametric analysis [for latencies (x=log 10 (y); for proportions (x=2×arc sine√y)].

Stepwise, feed-forward logistic regression analysis (using a likelihood ratio method) was conducted using SPSS version 10 [24 SPSS Inc: SPSS for Windows, version 10.0, Chicago].

The algorithm was applied to the scores of individuals in a non-clinical sample; a conversion probability of >0.05 was considered ‘High Risk’ (HR), whereas individuals whose scores generate a conversion probability of <0.05 were considered ‘Low Risk’ (LR).

In order to evaluate different means of using the model for the purposes of trial design/medical service planning/community screening, consideration is given to prognostic utility of the model (e.g. predictive values and relative risk) based on assessment at both one time point alone (Visit 1 [V1]), and based on concordant results of assessments at two time points separated by a 1-2 year interval (V1 & V2). By considering a prognosis based on two time points our aim was to decrease the likelihood of false positive Risk Classification.

### Statistical Analysis

Neuropsychological test results were analysed with SPSS 11.0 software. Relative risk calculations and associated confidence intervals were generated using ‘Confidence Interval Analysis’ software produced by M. J. Gardner and the British Medical Journal. In order to decrease skew and stabilise variances data were transformed prior to parametric analysis as appropriate.

### Results

### Clinical Status Four Years After Baseline

Of the original 155 subjects, 9 participants withdrew from the study and 5 died prior to assessment of neuropsychiatric outcome; the data of these individuals are excluded from the present analysis. Of the remaining 141 subjects, 25 met diagnostic criteria for amnestic MCI (Petersen, 2001), one of whom was diagnosed and died prior to visit 3. Two participants have developed probable AD (NINCDS-ADRDA), 4 subjects have been diagnosed with Vascular Cognitive Impairment and 110 patients did not meet any neuropsychiatric diagnostic criteria. The data of one additional subject are excluded from analysis due to a high baseline depression rating and missing data from subsequent visits.

### Identification of ‘High-’ and ‘Low-’ Risk Individuals

Based on PAL, GNT and age at V1 alone, 18 individuals (12.8% of the sample) received a ‘High Risk’ prognosis. Of these individuals 10 (7.1% of the sample) went on to receive a concordant ‘High Risk’ prognosis at their next assessment.

Table 1 shows the baseline clinical and demographic characteristics of the Low- and High Risk groups. There were no significant differences between the HR and LR groups in terms of NART-estimated IQ, affective status (GDS) nor, notably, in terms of levels of global cognitive function, as measured by MMSE (see FIG. 1A), suggesting that the prognostic groups were not differentiable on the basis of these standard clinical indices. As age is an important factor in the prognostic model it is entirely unsurprising that the HR group were significantly older than LR groups.

### Subsequent Cognitive Decline Over 24 Months in the ‘High’ Versus ‘Low’ Risk Groups

FIG. 1B shows the decline in global cognitive function in the HR and LR groups (baseline only prognosis) as indexed by mean change in MMSE score over 24 months. Individuals determined to be at High Risk based on scores from baseline visit alone showed significantly more deterioration in global cognitive function as indexed by change in MMSE score over 24 months (F _{1, 134}=7.21, p<0.01).

### Diagnostic Outcome 4 Years After Baseline in the Low- and High-Risk Groups

In order to evaluate the efficacy of the model as a predictor of clinical status 2×2 contingency tables were constructed (see tables 2/3) with outcome classified as either ‘Dementia Type’ (a group comprising all MCI and AD cases) or ‘Non-Dementia Type’ (a group comprising all other outcomes). Covariates were prognostic risk classification (LR/HR) based on V1 alone (table 2) or based on V1 & V2 (table 3).

Prognosis based on V1 alone had a high degree of specificity (95.6%) but a relatively moderate sensitivity to ‘Dementia Type’ (48.14%); 48% of incident MCI/AD cases were correctly predicted. This level of sensitivity is unsurprising as it has previously been shown that MCI is a heterogeneous group consisting of both individuals who will go on to convert to AD in a relatively short period of time and others who will either not convert or for whom conversion will take very much longer (Larrieu et al., 2003; Ritchie et al., 2001). The test generated a false positive prognosis in 5 cases. It is noteworthy that both incident AD cases were correctly predicted.

Relative Risk analysis of these data indicated that individuals receiving a ‘High Risk’ baseline prognosis are 6.29 (CI 95% 3.56-11.1) times more likely to go on to meet MCI/AD criteria (after four years) than individuals receiving a ‘Low Risk’ prognosis.

Prognosis based on V1 & V2 provides a more conservative index eliminating false positive prognoses. 10 cases receive a High Risk prognosis by these criteria and all these cases subsequently met MCI/AD status. Both AD cases are predicted. Relative Risk analysis indicated that individuals receiving a ‘High Risk’ prognosis (at both V1 and V2) are 7.65 (CI 95% 4.91-11.9) times more likely to go on meet MCI/AD criteria than individuals receiving a ‘Low Risk’ prognosis at either or both of V1 and V2.

The present study investigated the utility of a neuropsychological methodology in predicting, in a non-clinical community sample, the onset of neurocognitive disorder of a severity sufficient to meet criteria for amnestic MCI or AD.

The results revealed a subset of this non-clinical sample classified as ‘High Risk’ (of subsequent MCI/AD) four years prior to diagnostic assessment. This result is, in itself, remarkable given that all these individuals were recruited from the community and on the basis that they considered that their health, memory and thinking were good compared to that of their peers. This is indicative that poorer objective memory performance, adjudged by sensitive tests, may precede subjective memory complaints by some time.

Importantly, individuals classified as ‘high risk’ did not differ from ‘low risk’ individuals on any unanticipated demographic factor. Individuals classified as ‘High Risk’ at baseline were found to demonstrate a significantly greater degree of subsequent cognitive decline than those classified as ‘Low Risk’. This result suggests that this classification method is of value in announcing cognitive decline.

Diagnostic classification four years after baseline revealed that 25 individuals had progressed to meet criteria for amnestic MCI, and 2 individuals met criteria for AD (both incident AD cases were accurately predicted at baseline). Risk Classification was found to be predictive of MCI/AD diagnosis with a high degree of specificity; it is of particular importance that all 10 subjects receiving two successive ‘high risk’ classifications went on to meet MCI/AD criteria after V3. This result suggests that a higher degree of accuracy in predicting cognitive decline can be achieved by considering the results of neurocognitive assessment at two time points rather than the results of one assessment alone. Thus, the stability of MCI diagnoses may be augmented by stipulating that the results of two concordant neuropsychological assessments should be considered when classifying an individual as suffering from MCI.

The present results show that objectively defined memory impairments of visuospatial associative learning and naming may precede the subjective memory complaints which are integral to the announcement of cognitive decline. Tests of these abilities may therefore be useful in identifying individuals who are at risk of or susceptible to neurocognitive disorders such as MCI or AD.

### REFERNCES

Arnaiz E, Almkvist O (2003) Acta Neurol Scand Suppl 179:34-41.
Artero S, Ritchie K (2003) Aging Ment Health 7:251-8.
Birks J S, Harvey R (2003) Cochrane Database Syst Rev:CD001190.
Blackwell A D et al (2004): Dement Geriatr Cogn Disord 17:42-8.
Braak H, Braak E (1991) Acta Neuropathol (Berl) 82:239 59.
Budge M, et al (2000) Ann N Y Acad Sci 903:407-10.
Buschke H et al (1999) Neurology 52:231-8.
Busse A et al (2003) Acta Neurol Scand 108:71-81.
Cahn D A et al (1996) Arch Clin Neuropsychol 11:529-39.
Chandler L E et al (2003) Biochemistry 42:5508-14.
Darby D et al (2002) Neurology 59:1042-6.
De Jager C A et al (2002) Psychol Med 32:483-91.
De Jager C A et al (2003) Psychol Med 33:1039-50.
DeKosky S (2003) Alzheimer Dis Assoc Disord 17 Suppl 4:S99-104.
Flicker C et al (1991) Neurology 41:1006-9.
Bennett D A et al (2002) Neurology; 59 (2):198-205.
Folstein M F et al (1975) J Psychiatr Res 12:189-98.
Geldmacher D S et al (2003) J Am Geriatr Soc 51:937-44.
Graham N L et al (2004) J Neurol Neurosurg Psychiatry 75:61-71.
Hebert, L E et al Archives of Neurology August 2003; 60 (8): 1119-1122.
Kosky N (2002) J Psychopharmacol 16:181-2.
Larrieu S et al (2002) Neurology 59:1594-9.
McKhann G, Drachman D, Folstein M, Katzman R, Price D, Stadlan E M: Clinical diagnosis of Alzheimer's disease: report of the NINCDS-ADRDA Work Group under the auspices of the Department of Health and Human Services Task Force on Alzheimer's Disease. Neurology 1984; 34:939-944
McKeith I G et al (2003) Clin Neuropsychiatry 8:46-57.
McKenna P, Warrington E K (1980) J Neurol Neurosurg Psychiatry 43:781-8.
Nagy J I et al (1996) Brain Res 717:173-8.
Perry R J et al (2000) Neuropsychologia 38:252-71.
Petersen R C et al (1999) Arch Neurol 56:303-8.
Petersen R C et al (2001) et al Arch Neurol 58:1985-92.
Petersen R et al (2001b) Neurology 56:1133-42.
Petersen R C (2003) Nat Rev Drug Discov 2:646-53.
Ritchie K et al (2001) Neurology 56(1):37-42.
Rosler M, Frey U (2002) Fortschr Neurol Psychiatr 70:78-83.
Royall D R et al (1998) J Neurol Neurosurg Psychiatry 64:588-94.
Sahakian B J, Owen A M (1992) J R Soc Med 85:399-402.
Solomon P R, Pendlebury W W (1998) Fam Med 30:265-71.
Swainson R et al (2000) Neuropsychologia 38:596-612.
Swainson R et al (2001) Dement Geriatr Cogn Disord 12:265-80.
Tian J et al (2003) J Neurol Neurosurg Psychiatry 74:433-8.
Wentzel C et al (2000) Neuroepidemiology 19:186-93

TABLE 1

Visit 1
Classification

| | Low Risk | High Risk | |
|---|---|---|---|
| | (122) | (18) | p |
| Age | 73.67 | 81.13 | <0.01 |
| | (0.56) | (0.71) | |
| NART IQ | 118.28 | 115.82 | >0.05 |
| | (0.79) | (2.32) | |
| GDS | 4.31 | 5.76 | >0.05 |
| | (0.34) | (0.95) | |
| MMSE | 28.55 | 28.06 | >0.05 |
| | (0.13) | (0.41) | |

TABLE 2

Diagnostic Outcome

| Test Prognosis | Dementia Type | No Dementia | Total |
|---|---|---|---|
| High Risk | 13 | 5 | 72.22 |
| | | | (PPV) |
| Low Risk | 14 | 108 | 88.52 |
| | | | (NPV) |
| | 48.14 (SEN) | 95.57 (SPE) | |

TABLE 3

Diagnostic Outcome

| Test Prognosis | Dementia Type | No Dementia | Total |
|---|---|---|---|
| High Risk | 10 | 0 | 100 |
| | | | (PPV) |
| Low Risk | 17 | 113 | 86.92 |
| | | | (NPV) |
| | 37.03 (SEN) | 100.00 (SPE) | |

1. A method comprising:
assessing a visuospatial learning and memory ability of an individual,
assessing a semantic memory ability of the individual,
producing a visuospatial learning and memory ability score for the individual,
producing a semantic memory ability score for the individual, and
determining a risk of neurocognitive disorder in said individual using the visuospatial learning and memory ability score and the semantic memory ability score.

2. The method according to claim 1 wherein the individual has no neurocognitive abnormalities of a nature and severity consistent with a diagnosis of any neurocognitive disorder.

3. The method according to claim 1, wherein the determining of the risk of a neurocognitive disorder in said individual is further based on an age of the individual.

4. The method according to claim 1, further comprising classifying the individual as a high risk individual or a low risk individual on the basis of the determined risk of neurocognitive disorder.

5. The method according to claim 1, wherein the visuospatial learning and memory ability and the semantic memory ability of said individual are determined at two or more time points.

6. The method according to claim 5, further comprising classifying the individual as a high risk individual or as a low risk individual on the basis of a lowest determined risk of neurocognitive disorder at the two or more time points.

7. The method according to claim 1, wherein the assessing of the visuospatial learning and memory ability utilizes a paired associates learning and memory test.

8. The method according to claim 7, wherein the paired associates learning and memory test is a CANTAB-PAL test.

9. A method according to claim 8, wherein the visuospatial learning and memory ability score is a number of errors at a 6-pattern stage of the CANTAB PAL test.

10. The method according to claim 1, wherein the assessing of the semantic memory ability utilizes an object naming test.

11. The method according to claim 10, wherein the object naming test is a GNT test.

12. The method according to claim 11, wherein the semantic memory ability score is based on a number of errors made on the GNT test.

13. The method according to claim 1, wherein the assessing of the semantic memory ability utilizes a GNT test and the assessing of the visuospatial learning and memory ability utilizes a CANTAB-PAL test.

14. The method according to claim 13, wherein the determining of the risk of neurocognitive disorder in said individual utilizes the formula:
log odds AD(x)=−115.742+(4.254×age)+(6.517×Y)−(13.87×Z)
where Y=a number of errors at a 6-pattern stage of the CANTAB PAL and, Z=a total number of items named on the GNT divided by 30.

15. The method according to claim 1, further comprising identifying the individual as having a high risk of having a neurocognitive disorder or diagnosing the individual as having a neurocognitive disorder.

16. The method according to claim 15, further comprising providing anti-dementia therapy for administration to the individual.

17. The method according to claim 15, further comprising administering an anti-dementia therapy to the individual.

18. The method according to claim 17, further comprising monitoring a global cognitive function of the individual after administering the anti-dementia therapy.

19. A method comprising:
assessing a visuospatial learning and memory ability of a plurality of individuals,
assessing a semantic memory ability of the individuals,
producing visuospatial learning and memory ability scores for the individuals,
producing semantic memory ability scores for the individuals,
monitoring cognitive functions of the individuals over a time period to determine cognitive outcomes for the individuals, and
relating the visuospatial learning and memory ability scores, the semantic memory ability scores, and ages of the individuals with the cognitive outcomes to produce a predictive algorithm to determine a subject's risk of suffering from a neurocognitive disorder, or to diagnose the subject as having a neurocognitive disorder.

20. The method according to claim 19, wherein the test scores and cognitive outcomes of the individuals are related by multivariate logistic regression analysis.

21. The method according to claim 19, wherein the individuals in the sample have no neurocognitive abnormalities of a nature and severity consistent with a diagnosis of any neurocognitive disorder.

22. A method of assessing the risk of a neurocognitive disorder in an individual, the method comprising:
assessing a visuospatial learning and memory ability and assessing a semantic memory ability of the individual, to produce a visuospatial learning and memory ability score and a semantic memory ability score for the individual, and;
applying a predictive algorithm obtained by a method according to claim 19 to the scores and an age of the individual to determine a risk of neurocognitive disorder in the individual.

23. The method according to claim 22, wherein the individual does not display neurocognitive abnormalities of a nature and severity consistent with a diagnosis of any neurocognitive disorder.

24. A method comprising:
assessing a visuospatial learning and memory ability of a plurality of individuals,
assessing a semantic memory ability of the individuals,
producing visuospatial learning and memory ability scores for the individuals,
producing semantic memory ability scores for the individuals,
determining a risk of neurocognitive disorder in one or more of the individuals using the visuospatial learning and memory ability scores semantic memory ability scores, and
identifying at least one subject who has a higher risk of having a neurocognitive disorder than an individual of the plurality of individuals.

25. The method according to claim 24, wherein the individuals in the sample do not display neurocognitive abnormalities of a nature and severity consistent with a diagnosis of any neurocognitive disorder.

26. The method according to claim 24, wherein the assessing of the visuospatial learning and the memory ability utilizes a paired associates learning test.

27. The method according to claim 26, wherein the paired associates learning test is a CANTAB-PAL test.

28. The method according to claim 27, wherein the visuospatial learning ability score is based on a number of errors at a 6-pattern stage of the CANTAB PAL test.

29. The method of claim 24, wherein the assessing of the semantic memory ability utilizes an object naming test.

30. The method according to claim 29, wherein the object naming test is a GNT test.

31. The method according to claim 30, wherein the semantic memory ability score is based on a total number of items named on the GNT test.

32. The method according to claim 24, wherein the assessing of the semantic memory ability utilizes a GNT test and the assessing of the visuospatial learning and memory ability utilizes a CANTAB-PAL test.

33. The method according to claim 24, further comprising administering an anti-dementia therapy to an individual identified as having a high risk of having a neurocognitive disorder.

34. The method according to claim 33, further comprising monitoring the global cognitive function of the individual who was administered the anti-dementia therapy.

35. The method according to claim 24, further comprising;
administering a candidate anti-dementia therapy to one or more individual identified as having a high risk of having a neurocognitive disorder, and;
monitoring a global cognitive function of the one or more individuals relative to control members.

36. The method of claim 1, wherein the assessing the visuospatial learning and memory ability of the individual and the assessing the semantic memory ability of the individual are performed in a single operation.

37. The method of claim 1, wherein the producing the visuospatial learning and memory ability score for the individual and the producing the semantic memory ability score for the individual are performed in a single operation.

38. The method of claim 1, wherein the visuospatial learning and memory ability score for the individual and the semantic memory ability score for the individual are a single score.

39. The method of claim 1, wherein the method is a method of assessing a risk of neurocognitive disorder in an individual.

40. The method of claim 19, wherein the method is a method of producing a predictive diagnostic algorithm for a neurocognitive disorder.

41. The method of claim 19, wherein the subject is a member of the plurality of individuals.

42. The method of claim 19, wherein the subject is not a member of the plurality of individuals.

43. The method of claim 24, wherein the method is a method of identifying a population of individuals having a risk of neurocognitive disorder.

44. The method of claim 24, wherein the subject is a member of the plurality of individuals.

45. The method of claim 24, wherein the subject is not a member of the plurality of individuals.

46. A method comprising:
assessing a visuospatial memory ability of an individual
assessing a semantic memory ability of the individual,
producing a visuospatial memory ability score for the individual,
producing a semantic memory ability score for the individual, and
determining a risk of neurocognitive disorder in said individual using the visuospatial memory ability score and the semantic memory ability score.

47. A method comprising:
assessing a learning ability of an individual
assessing a memory ability of the individual,
producing a learning ability score for the individual,
producing a memory ability score for the individual, and
determining a risk of neurocognitive disorder in said individual using the learning ability score and the memory ability score.

48. A method according to claim 8, wherein the visuospatial learning and memory ability score is based on a number of user errors in the CANTAB PAL test.

49. A method according to claim 8, wherein the visuospatial learning and memory ability score is based on a total trials adjusted measure of a user using the CANTAB PAL test.

50. A method comprising:
assessing a visuospatial memory ability of a plurality of individuals,
assessing a semantic memory ability of the individuals,
producing visuospatial memory ability scores for the individuals,
producing semantic memory ability scores for the individuals,
determining a risk of neurocognitive disorder in one or more of the individuals using the visuospatial memory ability scores semantic memory ability scores, and
identifying at least one subject who has a higher risk of having a neurocognitive disorder than an individual of the plurality of individuals.

51. A method comprising:
assessing a learning ability of a plurality of individuals,
assessing a memory ability of the individuals,
producing learning ability scores for the individuals,
producing memory ability scores for the individuals,
determining a risk of neurocognitive disorder in one or more of the individuals using the learning ability scores and the memory ability scores, and
identifying at least one subject who has a higher risk of having a neurocognitive disorder than an individual of the plurality of individuals.

52. A method according to claim 8, wherein the visuospatial learning and memory ability score is based on a result of the CANTAB PAL test.

53. The method according to claim 1, wherein the individual has not been previously diagnosed as having neurocognitive abnormalities or a neurocognitive disorder.

54. The method according to claim 1, wherein the individual is asymptomatic.

55. The method according to claim 19, wherein at least one of the plurality of individuals has not been previously diagnosed as having neurocognitive abnormalities or a neurocognitive disorder.

56. The method according to claim 19, wherein at least one of the plurality of individuals is asymptomatic.

57. The method according to claim 24, wherein at least one of the plurality of individuals has not been previously diagnosed as having neurocognitive abnormalities or a neurocognitive disorder.

58. The method according to claim 24, wherein at least one of the plurality of individuals is asymptomatic.

59. The method according to claim 46, wherein the individual has not been previously diagnosed as having neurocognitive abnormalities or a neurocognitive disorder.

60. The method according to claim 46, wherein the individual is asymptomatic.

61. The method according to claim 47, wherein the individual has not been previously diagnosed as having neurocognitive abnormalities or a neurocognitive disorder.

62. The method according to claim 47, wherein the individual is asymptomatic.

63. The method according to claim 50, wherein the individual has not been previously diagnosed as having neurocognitive abnormalities or a neurocognitive disorder.

64. The method according to claim 50, wherein the individual is asymptomatic.

65. The method according to claim 51, wherein at least one of the plurality of individuals has not been previously diagnosed as having neurocognitive abnormalities or a neurocognitive disorder.

66. The method according to claim 51, wherein at least one of the plurality of individuals is asymptomatic.
